(19) United States
(12) Patent Application Publication
(10) Pub. No.: US 2012/0118685 A1
(43) Pub. Date: May 17, 2012

(54) COMPOSITE ARTICLE

(76) Inventors: David C. Johnson, Kenilworth (GB); Toby Hutton, Lillington (GB)

(21) Appl. No.: 13/298,625

(22) Filed: Nov. 17, 2011

(30) Foreign Application Priority Data
Nov. 17, 2010 (GB) GB1019454.6
Jul. 7, 2011 (GB) GB1111621.7

(51) Int. Cl. F16D 65/12; B64C 25/42

(52) U.S. Cl. 188/218 XL; 188/264 R

(57) ABSTRACT

A brake disc comprising a core layer and a wear layer, the core layer having a face and an external periphery, the wear layer being attached to the face, wherein the core layer comprises a C-C or refractory carbide first material and a plurality of distinct regions of a second material, the second material having a specific heat capacity and/or a volumetric specific heat capacity higher than the specific heat capacity and/or a volumetric specific heat capacity of the first material

This invention relates to a composite article which exhibits low wear and which has a high heat capacity. Particularly, but not exclusively, the invention relates to a carbon friction disc for use in, say, an aircraft brake.

For reasons of economic expediency, today's aircraft programmes are increasingly driven by the need to reduce weight. Such weight reductions allow for an increase in the payload to be carried and/or a reduction in the fuel required to fly the aircraft, both important considerations in times of decreasing or squeezed profit margins and greater environmental awareness.

Carbon-carbon composite (C-C) brake discs have become established as the material of choice for aircraft multi-disc brake systems where their relatively high cost is justified by their relatively lower weight compared with the metallic alternative. The high specific heat of carbon allows large quantities of energy to be absorbed by a low brake heat-pack mass during braking.

However, when measured volumetrically, the heat capacity of carbon is lower than the steel and metallic elements of conventional brake disks, in turn meaning that carbon heat sinks are required to be larger than equivalent steel heat sinks in order to have the same efficiency. This means that the components associated with the heat sink, for example the torque tubes and mountings, must also be larger, thereby increasing the weight of those components in a carbon heat sink as compared to a steel heat sink. Early developments in C-C brake discs found that some materials with low wear properties lacked the structural strength needed for the transfer of torque in the brake. A solution to this problem is proposed in U.S. Pat. No. 3,712,427 and U.S. Pat. No. 3,956,548 where low-wear carbon-based wear faces were attached by mechanical means or bonding to a carbon-based core material.

The high cost of C-C following its introduction as an aircraft brake friction material produced a desire for discs to be suitable for refurbishment and reuse without the need for complete replacement. U.S. Pat. No. 3,800,392 and U.S. Pat. No. 5,558,186 propose systems where wear faces could be removed from a carrier disc at the end of their service life and replaced with virgin material. U.S. Pat. No. 4,982,818 discloses a system wherein the core of a worn disc is split into two and each half is adhered to a virgin core to provide a new friction disc.

The minimum brake heat-pack mass, that is the reject mass at which the brake heat-pack must be removed from service (brake reject mass) is frequently determined by the energy to be absorbed during the most demanding braking event, the Reject-Take-Off (RTO). The required mass of a new heat-pack is determined by calculating the required reject mass plus an allowance for wearable material that is a function of wear rate per stop and number of stops the brake is required to perform during its service life.

In the past, C-C brake discs have been infiltrated with molten silicon and heat treated to react at least some of the silicon with the carbon of the matrix to form silicon carbide which improves the friction properties of the so-formed disc. Such materials are known to have a higher density than the C-C of the ‘base’ disc, the density of the siliconised material being typically in the range 1.9-2.2 gcm⁻³. However, the wear rate of such siliconised brake discs is typically significantly higher than that of a corresponding C-C disc, thus requiring a longer heat-pack of higher density and thereby increasing overall weight of the wheel and brake.

It is an object of this invention to provide a composite article which exhibits an improved capacity for energy absorption and/or a low wear rate in use when in frictional engagement with another composite article of the invention or other article.

It is a particular but not exclusive objective of the invention to provide a composite article which is suitable for use as a friction disc in an aircraft brake, the disc having one or both of an improved capacity for energy absorption and a low wear rate to minimise the weight of a heat-pack and/or to reduce the length of a so-formed heat-pack. It is postulated that by reducing the length of the heat-pack the length of a surrounding brake chassis and other wheel components will be reduced, concomitantly reducing the weight of the aircraft.

In a first aspect the invention provides a composite article (e.g. a brake disc), say for use in an aircraft brake heat pack, the article comprising a core layer and a wear layer, wherein the core layer comprises a C-C or refractory carbide first material and at least one (e.g. a plurality of) distinct region(s) of a second material having a specific heat capacity and/or a volumetric specific heat capacity higher than the specific heat capacity and/or a volumetric specific heat capacity of the first material.

The wear layer may be formed integrally with the core or may be joined thereto as a separate integer. For example, the core layer may have a face portion to which the wear layer is attached, e.g. by mechanical means (rivets, fasteners and so on) and/or through chemical means (e.g. during the CVD, impregnation or other processes).

Preferably, the region(s) of the second material are all positioned inwardly of an external periphery of the article.

A second aspect of the invention provides a ventilated disc, the disc comprising a substantially annular core having first and second major faces, an internal periphery and an external periphery, at least one opening or passageway extending radially from the external periphery toward the internal periphery to provide a flow passage, the core being fabricated, at least in part from a C-C material or from a refractory carbide material, with at least one passageway being at least partially lined with a second material having a specific heat capacity and/or a volumetric specific heat capacity higher than the specific heat capacity and/or a volumetric specific heat capacity of the first material.

The some or each opening or passageway may extend to the internal periphery. Alternatively, the some or each opening or passageway may extend only part way to the internal periphery. The some or each opening or passageway may be lined along the whole or part of its length and/or around the entirety or part of its periphery with said second material.

The second material may be further provided within the core outside of the opening or passageway(s).

Preferably, when the first material is C-C, the second material has, at room temperature, a specific heat capacity (C₂) of greater than 0.71 Jg⁻¹° C.⁻¹ and/or a volumetric specific heat capacity (C_{V2}):

$${C}_{V 2} ⊳ \frac{{ρ}_{1}}{1.85} \times 1.313 J {cm}^{- 3 °} {C}^{- 1}$$

where ρ₁ is the density of the first material.

Preferably, the second material has a melting point of 1000° C. or higher. The second material preferably has a melting point sufficiently high to ensure that the second material does not melt during use of the article or disc. Advantageously, this obviates the need to take special measures to ensure containment of the second material, which is necessary if that material melts during use. The values of heat capacity C₂ and/or C_{V2} will most preferably remain above that and/or those of the first material across the entire operating range of the article or disc, thereby providing the benefit across the operating range of the article or disc.

A third aspect of the invention provides a composite article for use in an aircraft brake heat pack, the article comprising a core layer having a face portion and a wear layer attached to or integral with the face portion, wherein the core layer comprises a C-C or refractory carbide material and one or more discrete zones of a second material, the second material being one or more of boron, beryllium or compounds of boron, beryllium and/or lithium.

Preferably, the region(s) of the second material are all positioned inwardly of an external periphery of the article.

There is further provided, in a third aspect of the invention, a composite article for use in an aircraft brake heat pack, the article comprising a core layer and a face layer (e.g. a wear layer), wherein the core layer comprises a C-C or refractory carbide material and a second material, wherein the second material is provided on and/or in a core layer precursor prior to densification of the core layer, and wherein the second material comprises BN, Li₂O or LiAlO₂.

In a further aspect the invention provides a brake disc for use in an aircraft brake heat pack, the disc comprising a core layer and a wear layer, wherein the wear layer comprises a first material and the core layer comprises the first material and plural distinct regions of a second material having a specific heat capacity (C₂) of greater than 0.71 Jg⁻¹° C.⁻¹ and/or a volumetric specific heat capacity (C_{V2}):

$${C}_{V 2} ⊳ \frac{{ρ}_{1}}{1.85} \times 1.313 J {cm}^{- 3 °} {C}^{- 1}$$

where ρ₁ is the density of the first material and where the second material has a melting point (T_{M2}) of 1000° C. or higher and does not exhibit a state change during use.

The face layer or wear layer may be formed integrally with the core or may be joined thereto as a separate component. For example, the core layer may have a face portion to which the face or wear layer is attached, e.g. by mechanical means (rivets, fasteners and so on) and/or through chemical means (e.g. during the CVD, impregnation or other processes) and/or through high temperature brazing.

The core layer may be formed in two parts, each having a face or wear layer, the two being joined together to form that article or disc.

Preferably, the core layer comprises from above 0 to 20 w/w % of the second material. In some embodiments the core layer comprises above 20 w/w %, for example above 30, 35, 40, 45, 50, 55, 60 w/w %, for example at least 70, 75 or 80 w/w %, e.g. at least 90 or 95 w/w %, of the second material.

In some embodiments, the second material comprises boron fibres, for example boron fibres embedded within a matrix (e.g. a carbon matrix). More preferably, the second material comprises a boron-boron composite, i.e. boron fibres embedded in a boron matrix.

Preferably, the refractory carbide material, if present, comprises Si—C.

Preferably, the second material is provided in one or more distinct zones in the core layer.

In some embodiments, the distinct zones comprise linings formed in one or more recesses (e.g. ventilation recesses) extending inwardly from an outer circumference of the core layer.

Preferably, the linings are of a sufficiently high density that the core layer including the lined recesses has a mass equal to or greater than an identically dimensioned core layer absent any recesses.

Preferably, the second material comprises one or more of boron, beryllium or compounds of boron, beryllium and/or lithium.

Preferably, the second material comprises at least one of BN, B₄C, Li₂O or LiAlO₂.

In some embodiments, the core layer comprises at least 70 w/w % C-C, for example at least 80 w/w % C-C.

Preferably, the core layer comprises up to 30 vol/vol % of the second material. For example, the core layer may comprise 5 vol/vol % to 25 vol/vol %. In some embodiments the core layer may comprise above 30 vol/vol %, e.g., above 35, 40, 45, 50, 55, 60, 65, 70, 75, 80, 85, 90, 95 vol/vol %.

Preferably, the second material comprises one or more inserts within the core layer.

Preferably, the one or more inserts is at least partially, e.g. entirely, encapsulated within the core layer.

Preferably, at least one of the inserts comprises a sintered article. In some embodiments, the sintered article may comprise a non-stoichiometric mixture of elements and/or compounds.

Preferably the sintered articles comprise a first component (for example selected from boron, beryllium or compounds of boron, beryllium or lithium) and a second component (for example LiF). In some embodiments, the second component comprises 10 to 25 w/w % or less of the sintered article.

Preferably, at least one of the inserts has a density of at least 90% (e.g. at least 95%) of the theoretical density of second material.

Preferably, the second material is provided on and/or in a core layer precursor prior to densification of the core layer, and wherein the second material comprises BN, Li₂O or LiAlO₂.

Preferably, the core layer comprises at least 70 w/w % C-C, for example at least 80 w/w % C-C.

Preferably, the wear face comprises substantially exclusively C-C.

In order that the invention may be more fully understood, it will now be described by way of example only and with reference to the accompanying drawings, in which:

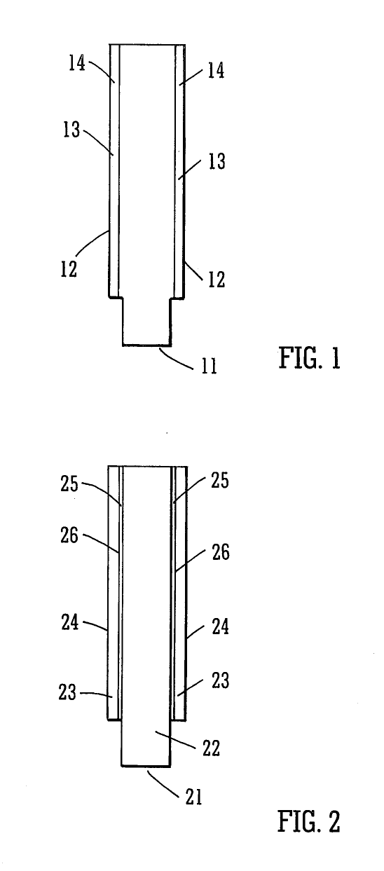

FIG. 1 is an illustration of a cross section through a prior art C-C brake disc showing regions of wearable carbon;

FIG. 2 is an illustration of a cross section through a disc of the invention showing the C-C wear faces bonded to a core;

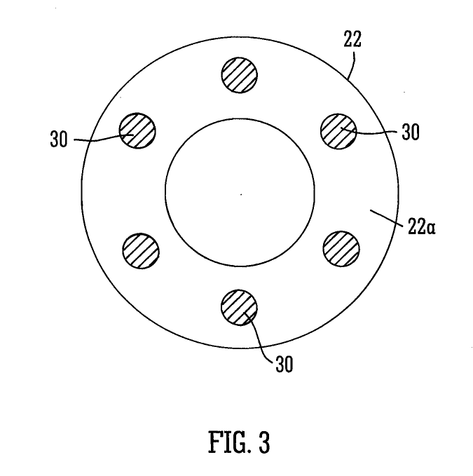

FIG. 3 is an illustration of a cross section through a disc of the invention showing the C-C wear faces removed and regions for high energy capacity inserts;

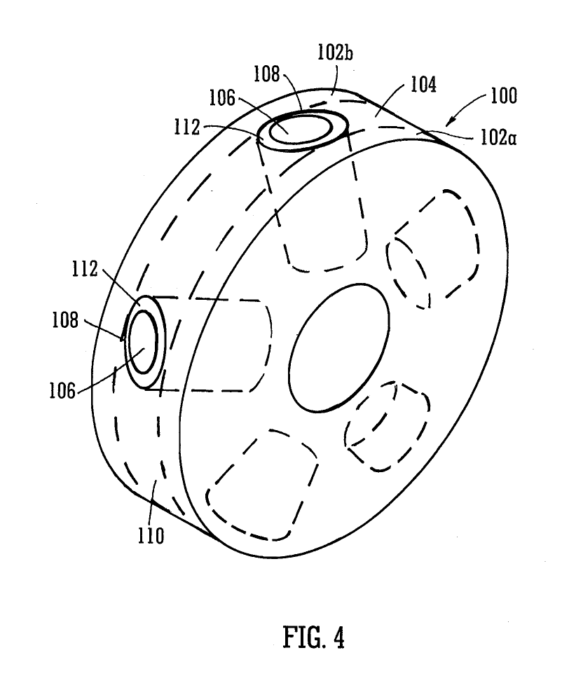

FIG. 4 is an illustration of a brake disc according to the invention;

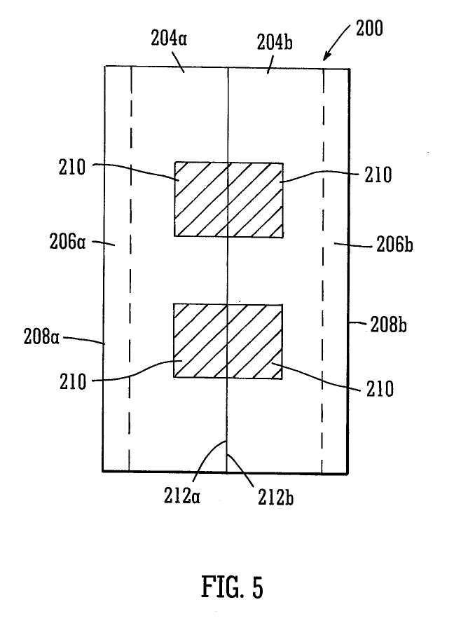

FIG. 5 is an illustration of a brake disc according to the invention.

Referring to FIG. 1, a sectional view of a prior art brake disc for an aircraft multi-disc brake is shown. Here, a C-C rotor brake disc 11 is shown with drive keys (not shown) on the outer periphery thereof for engagement into an aircraft wheel (not shown). The brake disc 11 has two wear surfaces 12, one on each major face of the disc 11 for frictional engagement with discs located either side thereof when installed in a brake assembly. As the disc 11 wears during use, the wear surfaces 12 will progress through the thickness of the underlying material 13 until position 14 is reached, at which point the disc 11 is fully worn and will be replaced.

A brake assembly known in the art typically has C-C rotor discs keyed to and rotating with the wheel and interleaved between C-C stator discs keyed to a torque tube which is mounted to the landing gear leg axially around the axle. The assembly of stator and rotor discs is known as a “heat pack”. The friction faces of the discs become frictionally engaged when the brake pressure load is applied by the actuator pistons in the brake piston housing. The actuator pistons can be actuated hydraulically or electrically by brake control systems. As the brake friction discs wear at the frictionally engaging surfaces, the thickness of the heat pack is reduced, the reduction in thickness normally being shown by a wear indicator mechanism. When the heat pack reaches its fully worn thickness the heat pack is removed and replaced with new discs. The length of the heat pack at this fully worn condition is known as the reject heat pack length.

FIG. 2 is a sectional view through a brake disc 21 of the invention. The brake disc 21 comprises a core portion 22, attached to the faces 25 of which core portion 22 are wear portions 23, which have wear surfaces 24 for frictional engagement with an adjacent brake disc (not shown) in use. The wear portions 23 may be bonded to the core 22 by mechanical means, such as rivets and the like, by chemical bonding agents such as a high temperature brazing alloy, for example Nicrobraz 30 supplied by Wall Colmonoy Corporation, or by diffusion bonding as is well known in the art.

The wear faces 23 have a thickness of wearable material available, the limit of which is shown at position 26. Brake discs 21 are shown with two wear faces 23, however, it will be appreciated that some brake discs might only have one wear face, in particular those stators at the ends of the heat pack. Wear faces 23 could be of C-C material (of, say, density of 1.6 to 1.85 gcm⁻³) or other material having suitable wear rate and friction properties for application as an aircraft brake disc.

The core portion 22 is shown in profile and separately from the wear portions 23 in FIG. 3. The main body 22a of the core portion is formed from C-C or a suitable refractory material, however a plurality of inserts 30 are embedded within the main body 22a of the core portion 22.

The inserts are made from a material which has a higher volumetric specific heat capacity than C-C (which, at a density of 1.8 gcm⁻³, has a volumetric specific heat capacity of 1.28 J/cm³/° C. at room temperature), thereby increasing the volumetric specific heat capacity of the core portion 22 as a whole.

Ideal materials for the inserts 30 also have a higher specific heat capacity than C-C (which has a specific heat capacity of 0.71 J/g/° C. at room temperature) and/or a higher volumetric specific heat capacity than C-C (which, at a density of 1.85 gcm⁻³, has a volumetric specific heat capacity of 1.31 J/cm³/° C. at room temperature), thereby offering the greatest heat sink performance for the weight and volume of the insert.

Ideal materials also have melting points above the typical operating temperatures of the heat sink, in order to prevent phase change during braking operations.

Appropriate materials may be selected from boron, beryllium, BN, B₄C, Li₂O or LiAlO₂, the heat capacities and densities of which are shown in Table 1, below. Other compounds of boron, beryllium and lithium may also provide appropriate characteristics.

TABLE 1

| | Specific | | Volumetric Specific | |
|---|---|---|---|---|
| | Heat Capacity | Density | Heat Capacity | Melting |
| Material | (J/cm³/° C.) | (g/cm³) | (J/cm³/° C.) | Point (° C.) |
| B | 1.02 | 2.34 | 2.4 | 2300 |
| Be | 1.82 | 1.85 | 3.37 | 1278 |
| BN | 1.04 | 2.25 | 2.34 | 3000 |
| B₄C | 0.96 | 2.52 | 2.42 | 2350 |
| Li₂O | 2.16 | 2.01 | 4.34 | 1570 |
| LiAlO₂ | 1.19 | 2.61 | 3.11 | >1625 |

The inserts 30 may be manufactured by sintering powders of one or more of these materials, for example by hot isostatic pressing. Using such methods, it is possible to achieve densities at or close to the theoretical density of the materials, thereby ensuring that volume of the insert is minimised and heat capacity is maximised.

The inserts 30 are preferably bonded in corresponding holes or recesses in the core portion 22. Alternatively, however, the inserts 30 may be held in place by the wear faces 23, once those wear faces 23 have been fixed to the core portion 22 ready for use.

The brake disc 21 so produced accordingly has high heat capacity for both its weight and its volume as compared to the brake discs of the prior art. Accordingly, weight savings are made not only on the disc 21 itself, but on the ancillary fittings, as the length of a complete heat pack of, say, five or six discs 21, may be very much reduced as compared to the prior art and those ancillary fittings may therefore be smaller and lighter.

In an alternative embodiment, the high heat capacity material is provided in the core at the time of manufacture of the C-C material used to make it. In the manufacture of these core portions, the high heat capacity material is added in a powdered form onto layers of carbon fabric, on the area or areas where it is required. The powder could be left on the fabric or incorporated deeper into the fabric by, for example, applying vibration to the fabric. Layers of fabric with the high heat capacity powder added are then built up, one on top of another, until the required weight of fibre and powder is reached. In some alternative embodiments, the powder could be incorporated into an aerosol and sprayed onto the fabric.

The layers of fabric can then be compressed to the required fibre volume in a jig, by needling and/or by needling pitch or resin. CVI or an impregnation and char route can then densify discs to the required density. This will produce a disc with carbon fibre reinforcement and a matrix containing carbon and the high heat capacity material.

In some alternative embodiments, the high heat capacity material (or a precursor thereof) may be introduced to the preform in the form of a solution, sol, liquid or CVI gas precursor prior to densification.

The high heat capacity materials used in this embodiment are preferably selected from BN, Li₂O or LiAlO₂.

Wear portions 23 may then be attached to the core portion 22 as is described above to make the complete disc 21.

In all embodiments where the second material is not performing a structural function, it is preferred that the core layer comprises at least 70 w/w % (for example at least 80 w/w %) C-C. Additionally or alternatively, it is preferred that the core layer may comprise up to 30 vol/vol % second material (e.g. up to 30 vol/vol % of the core layer comprises the one or more inserts 30). However, if the second material is capable of performing a structural function, the proportion of second material may be much higher, for example above 60 w/w %.

It will be thus appreciated by the skilled addressee that by using brake heat packs comprising the brake discs of the invention many advantages can be delivered. For example, the length of the new heat pack can be reduced leading to concomitant reductions in wheel and brake weight. Moreover, the use of a bond layer with low thermal conductivity opens the possibility of operating the wear surfaces at a temperature that reduces wear and/or improves friction performance, particularly during aircraft taxi-out when wear in C-C brake discs has been found to be disproportionately high for the brake energy involved.

In addition it will be appreciated that the use of wear faces allows discs to be readily refurbished by the removal of fully worn wear faces and replacement with new faces bonded to the core. Such a refurbishment capability gives considerable economic benefits in the operation of composite brake discs.

It is envisaged that wear faces can be attached to core discs with a flat surface or the wear faces can be attached into a recessed area in the core.

In any of the above described embodiments, it is preferred that the inserts 30 are manufactured using powder metallurgy techniques. In particular, these techniques ensure that the chemical make-up of the inserts need not be bound by the stoichiometry of the elements or compounds it comprises, rather blends of metals and/or compounds thereof may be made to provide, e.g. a particular specific heat capacity or volumetric heat capacity.

For example, lithium fluoride may be included in a quantity of, say, less than 10 w/w % of the second material. This aids sintering in the powder mix whilst maintaining a high melting point of the material above 1200° C. when co-sintered with boron, beryllium, BN, B₄C, Li₂O or LiAlO₂. This approach offers potential to raise both J/g and in addition help densification raising sintered density and hence J/cm³.

In an alternative embodiment, the invention provides a ventilated brake disc 100, as is shown in FIG. 4.

The disc 100 may comprise a laminar structure of wear faces 102a, 102b attached to a core layer 104, though may also comprise a unitary structure.

The disc comprises a plurality of recesses 106 extending from openings 108 around the circumferential periphery 110 of the disc. The recesses 106 extend inwardly in a radial direction from the openings 108, so as to allow the disc 100 to be ventilated.

The internal walls of the recesses 106 are provided with a secondary material 112 which is denser than the core material. The secondary material may be provided as an insert or a coating. The insert or coating is sufficiently thick that its mass is equivalent to the mass of the core material of the same volume as the recess 106. In this way, the disc is enabled to be ventilated without needing to increase the overall volume of the disc to compensate for a loss in overall mass and heat capacity.

The second material preferably comprises boron, beryllium or compounds of boron, beryllium and/or lithium.

In a further embodiment of the invention, as is shown in FIG. 5, a two part brake disc 200 is provided.

Each part 202a, 202b comprises a core portion 204a, 204b predominantly comprises C-C impregnated with silicon carbide, and wear portions 206a, 206b, each having wear faces 208a, 208b, the wear portions 206a, 206b comprising C-C.

Inserts 210 of a second material having a higher specific heat capacity and/or volumetric specific heat capacity than C-C are held in corresponding recesses in inner faces 212a, 212b of the core portions 204a, 204b.

The second material preferably comprises boron, beryllium or compounds of boron, beryllium and/or lithium.

In the embodiment shown, the parts 212a, 212b are unitary forms, for example made by laying up layers of carbon fabric and adding silicon powder to a portion of the layers intended to form the core portion 204, followed by densification of the fabric layers (for example, in a similar manner to that described in EP1260729).

Alternative embodiments provide the parts 212a, 212b as laminate parts which comprise separate and optionally separable wear faces and core regions.

Whilst the invention has been described in relation to aircraft brake discs, it may also be used in, say, clutch discs and other friction discs and the like, where savings of weight are/or size are desirable. For example, articles of the invention may be used as heat sinks in aerospace and/or space applications. For example, the articles may be presented as shaped tiles, which may be regular or irregular.

In some of the above-identified applications the discs are solid with internal porosity, i.e. there are no through holes for air flow. In some of the above cases, where such holes are not mentioned, such holes may be present. In which case, where the density of the core material is mentioned, it is the density of the actual core material rather than the bulk density of the entire core volume (i.e. including the holes) that is referred to.

It will be appreciated that, although several embodiments have been disclosed, it is understood by the person skilled in the art that those embodiments may be combined and/or elements of each may be combined, substituted or deleted, the scope of the invention being determined by the broadest statements of invention and/or the Claims appended hereto.

1. A brake disc comprising a core layer and a wear layer, the core layer having a face and an external periphery, the wear layer being attached to the face, wherein the core layer comprises a C-C or refractory carbide first material and a plurality of distinct regions of a second material, the second material having a specific heat capacity and/or a volumetric specific heat capacity higher than the specific heat capacity and/or a volumetric specific heat capacity of the first material.

2. A disc according to claim 1, wherein the wear layer is formed integrally with the core.

3. A disc according to claim 1, wherein the wear layer is joined to the core as a separate integer.

4. A disc according to claim 3, wherein the wear layer is attached to the core layer by mechanical means (rivets, fasteners and so on) and/or through chemical means (e.g. during the CVD impregnation, high temperature brazing, or other processes).

5. A disc according to claim 1 wherein the regions of second material are all positioned inwardly of the external periphery.

6. A disc according to claim 1, wherein the first material is C-C, the second material has, at room temperature, a specific heat capacity (C₂) of greater than 0.71 Jg⁻¹° C.⁻¹ and/or a volumetric specific heat capacity (C_{V2}):
$${C}_{V 2} ⊳ \frac{{ρ}_{1}}{1.85} \times 1.313 J {cm}^{- 3 °} {C}^{- 1}$$
where ρ₁ is the density of the first material.

7. A disc according to claim 6, wherein the values of heat capacity C₂ and/or C_{V2} remain above that and/or those of the first material across the entire operating range of the article or disc.

8. An article or disc according to claim 1, wherein the core layer is formed in two parts, each having a face or wear layer, the two being joined together to form that article or disc.

9. An article or disc according to claim 1, wherein the second material comprises above 0 to 25 w/w %, or above 20 w/w %, for example above 30, 40, 50, 60 w/w %, for example at least 70 w/w %, e.g. at least 90 w/w %, of the core layer.

10. An article or disc according to claim 1, wherein the second material comprises one or more inserts within the core layer.

11. An article or disc according to claim 10, wherein at least one of the inserts comprises a sintered article.

12. An article or disc according to claim 11, wherein the sintered article may comprise a non-stoichiometric mixture of elements and/or compounds.

13. An article or disc according to claim 11, wherein the sintered article comprises a first component (for example selected from boron, beryllium or compounds of boron, beryllium or lithium) and a second component (for example LiF).

14. An article or disc according to claim 13, wherein the second component comprises 20 w/w % or less of the sintered article.

15. An article or disc according to claim 13, wherein at least one of the inserts has a density of at least 90% (e.g. at least 95%) of the theoretical density of second material.

16. An article or disc according to claim 1, wherein the wear face comprises substantially exclusively C-C.

17. A disc according to claim 1, wherein the second material has a melting point of 1000° C. or higher.

18. A disc according to claim 1, wherein the second material has a melting point sufficiently high to ensure that the second material does not melt during use of the article or disc.

19. A ventilated disc, the disc comprising a substantially annular core having first and second major faces, an internal periphery and an external periphery, at least one passageway extending radially from the external periphery toward the internal periphery to provide a flow passage, the core being fabricated, at least in part from a C-C material or from a refractory carbide material, the at least one passageway being at least partially lined with a second material having a specific heat capacity and/or a volumetric specific heat capacity higher than the specific heat capacity and/or a volumetric specific heat capacity of the first material.

20. A disc according to claim 19, wherein the first material is C-C, the second material has, at room temperature, a specific heat capacity (C₂) of greater than 0.71 Jg⁻¹° C.⁻¹ and/or a volumetric specific heat capacity (C_{V2}):
$${C}_{V 2} ⊳ \frac{{ρ}_{1}}{1.85} \times 1.313 J {cm}^{- 3 °} {C}^{- 1}$$
where ρ₁ is the density of the first material.

21. A disc according to claim 20, wherein the values of heat capacity C₂ and/or C_{V2} remain above that and/or those of the first material across the entire operating range of the article or disc.

22. A composite article for use in an aircraft brake heat pack, the article comprising a core layer the core layer having a face and an external periphery, the wear layer being attached to or integral with the face, wherein the core layer comprises a C-C or refractory carbide material and one or more discrete zones of a second material, the second material one or more of boron, beryllium or compounds of boron, beryllium and/or lithium and being located inwardly of the external periphery.

23. A composite article for use in an aircraft brake heat pack, the article comprising a core layer and a face layer (e.g. a wear layer), wherein the core layer comprises a C-C or refractory carbide material and a second material, wherein the second material is provided on and/or in a core layer precursor prior to densification of the core layer, and wherein the second material comprises BN, Li₂O or LiAlO₂, and wherein the face layer is substantially free of the second material.

24. A brake disc for use in an aircraft brake heat pack, the disc comprising a core layer and a wear layer, wherein the wear layer comprises a first material and the core layer comprises the first material and plural distinct regions of a second material having a specific heat capacity (C₂) of greater than 0.71 Jg⁻¹° C.⁻¹ and/or a volumetric specific heat capacity (C_{V2}):
$${C}_{V 2} ⊳ \frac{{ρ}_{1}}{1.85} \times 1.313 J {cm}^{- 3 °} {C}^{- 1}$$
where ρ₁ is the density of the first material and where the second material has a melting point (T_{M2}) of 1000° C. or higher and does not exhibit a phase change during use.

25. A disc according to claim 24, wherein the values of heat capacity C₂ and/or C_{V2} remain above that and/or those of the first material across the entire operating range of the article or disc.
